(19) United States
(12) Patent Application Publication
(10) Pub. No.: US 2017/0084017 A1
(43) Pub. Date: Mar. 23, 2017

(54) METHOD AND APPARATUS FOR PREDICTING CHLOROPHYLL-a CONCENTRATION IN RIVER USING SATELLITE IMAGE DATA AND NONLINEAR RANSAC METHOD

(71) Applicant: INDUSTRY ACADEMIC COOPERATION FOUNDATION KEIMYUNG UNIVERSITY, Daegu (KR)

(72) Inventors: Byoung Chul KO, Daegu (KR); Hyeong Hun KIM, Daegu (KR); Jae Yeal NAM, Daegu (KR); Sang Won PARK, Daegu (KR)

(21) Appl. No.: 15/000,150

(22) Filed: Jan. 19, 2016

(30) Foreign Application Priority Data
Sep. 17, 2015 (KR) 10-2015-0131899

(51) Int. Cl. G06T 7/00; G06T 7/60; G06K 9/52; G06K 9/62; G06T 5/00; G06K 9/66

(52) U.S. Cl. CPC G06T 7/0004; G06T 5/00; G06K 9/66; G06K 9/52; G06K 9/6267; G06T 7/60; G06T 2207/30181; G06T 2207/20172; G06T 2207/10032

(57) ABSTRACT

Disclosed herein is a method for predicting a chlorophyll-a concentration in a river using satellite image data and a nonlinear RANSAC method. In detail, the method includes (1) receiving a chlorophyll-a concentration, which was actually measured at a measurement station at a prescribed basin and an image from a satellite on a same date and at a same site as when and where the chlorophyll-a concentration was measured at the measurement station, (2) correcting a distortion of the image received from the satellite, (3) applying the chlorophyll-a concentration actually measured at the measurement station and data of the corrected satellite image to a nonlinear RANSAC method to extract a second-order function, and (4) inputting corrected data of a satellite image collected at the prescribed basin to the extracted second-order function to predict a chlorophyll-a concentration at the prescribed basin.

### CROSS-REFERENCE TO RELATED APPLICATIONS

This application claims the benefit of Korean Application No. 10-2015-0131899, filed on Sep. 17, 2015, the disclosures of which are incorporated by reference into the present application.

### BACKGROUND OF THE INVENTION

1. Field of the Invention

The present invention relates generally to a method and system for predicting a chlorophyll-a concentration and, more particularly, to a method and apparatus for predicting a chlorophyll-a concentration in a river using satellite image data and a nonlinear RANSAC method.

2. Description of the Related Art

Due to the effects of recent global warming, pollution levels in waters including rivers, reservoirs, lakes, etc., have been increasing every year. In particular, as water temperatures increase, eutrophication, caused primarily by an increase in chlorophyll-a, disturbs aquatic ecosystems as well as pollutes drinking water resources.

Current water quality, including measurements of chlorophyll-a concentrations in rivers, is managed in a manner whereby the Korea Environment Corporation and each local government install measurement devices at main water areas to remotely measure water quality and then deliver the measurement information to measurement stations for monitoring pollution levels. Such a method is advantageous in that accurate measurement values may be obtained from watersheds, but has limitations in that it is not plausible to install measurement devices at all positions of all rivers in the country. Further, frequent malfunctioning and maintenance of the measurement devices is costly. In order to make up for such limitations, recently, development has been ongoing into a method that estimates chlorophyll-a concentrations by extracting a recursive function based on satellite image data and inputting satellite image data values to the extracted recursive function. However, the recursive function extracted in an existing manner has a limitation of being largely influenced by outlier data. Regarding measurement of water quality of rivers, Korean Patent Laid-Open Application publication No. 10-2012-0098158, published on Sep. 5, 2012, discloses a system for measuring water pollution using a water quality measurement sensor and a gas concentration measurement sensor.

### SUMMARY OF THE INVENTION

Accordingly, the present invention has been made keeping in mind the above problems occurring in the prior art, and an object of the present invention is to provide a method and apparatus for predicting a chlorophyll-a concentration in a river using satellite image data and a nonlinear random sample consensus (RANSAC method) method, which is capable of effectively predicting a wide range of chlorophyll-a concentrations in rivers by inputting satellite image data collected at a specific basin to a second-order function, which is extracted by applying, to the nonlinear RANSAC method, chlorophyll-a concentrations, which were actually measured at a measurement station at the specific basin, and image data, which was obtained from a satellite on the same date and at the same site as when and where the chlorophyll-a concentrations were measured at the corresponding measurement station.

Another object of the present invention is to provide a method and apparatus for predicting a chlorophyll-a concentration in a river using satellite image data and a nonlinear RANSAC method, which is capable of minimizing an effect of outlier data and predicting the chlorophyll-a concentration more accurately.

In order to accomplish the above object, the present invention provides a method for predicting a chlorophyll-a concentration in a river using satellite image data and a nonlinear RANSAC method. The method includes: (1) receiving chlorophyll-a concentration, which was actually measured at a measurement station at a prescribed basin and an image from a satellite on a same date and at a same site as when and where the chlorophyll-a concentration was measured at the measurement station; (2) correcting a distortion of the image received from the satellite; (3) applying the chlorophyll-a concentration actually measured at the measurement station and data of the corrected satellite image to a nonlinear RANSAC method to extract a second-order function; and (4) inputting corrected data of a satellite image collected at the prescribed basin to the extracted second-order function to predict a chlorophyll-a concentration at the prescribed basin.

In step (1), an operational land imager sensor image provided from LANDsat 8 satellite may be received.

Step (2) may include: (2-1) converting a value of a digital number in the image received from the satellite into a top of atmosphere (TOA) reflectance ratio by using the following Equation:

ρλ′=M_{ρ}Q_{cal}+Aₚ

where ρλ′ denotes a TOA reflectance ratio to which a sun angle is not considered, M_{ρ} denotes a multiplicative rescaling factor of a metadata file, Aₚ denotes an additive rescaling factor of a metadata file, and cal denotes a pixel of the image.

Step (2) may further include: (2-2) extracting a TOA reflectance ratio, for which a sun angle is considered, from the TOA reflectance ratio converted in step (2-1) by using the following Equation:

$$ρ λ = \frac{ρ {λ}^{′}}{cos ( {θ}_{SZ} )} = \frac{ρ {λ}^{′}}{sin ( {θ}_{SE} )}$$

where ρλ denotes the TOA reflectance ratio for which the sun angle is considered, θ_{SE} denotes a sun angle at a measurement area, and θ_{SZ} denotes a solar zenith angle.

Step (3) may include (3-1) generating sample data in which the corrected data of the satellite image, which was received on the same date and at the same site as when and where the chlorophyll-a concentration was measured at the measurement station, is taken as x, and a value of the chlorophyll-a concentration, which was actually measured at the measurement station, is taken as y.

Step (3) may further include: (3-2) randomly extracting three sample data points of P1(x₁,y₁), P2(x₂,y₂), and P3(x₃,y₃) from among the sample data generated in step (3-1).

Step (3) may further include: (3-3) substituting the three points extracted in step (3-2) to the following Equation to obtain a second-order function crossing the three points:

y=ax²+bx+c.

Step (3) may further include (3-4) obtaining a number N of data of which distances to the second-order function obtained in step (3-3) are equal to or greater than a prescribed value.

Step (3) may further include: (3-5) storing N as a new maximum value N_max of N when N obtained in step (3-4) is greater than a stored maximum value N_max of N and storing a corresponding second-order function.

Step (3) may further include: (3-6) determining, as a final second-order function, a second-order function stored after repeating steps (3-2) to (3-5) a prescribed number of times.

In order to accomplish the above object, the present invention also provides a system for predicting a chlorophyll-a concentration in a river using satellite image data and a nonlinear RANSAC method. The system includes: an input module receiving a chlorophyll-a concentration at a predetermined basin, which was actually measured at a measurement station and an image from a satellite on a same date and at a same site as when and where the chlorophyll-a concentration was measured at the measurement station from a satellite; a correcting module correcting a distortion of an image received from the satellite; a function extracting module applying the chlorophyll-a concentration actually measured at the measurement station and data of the corrected satellite image to a nonlinear RANSAC method to extract a second-order function; and a chlorophyll-a concentration predicting module inputting corrected data of a satellite image collected at the prescribed basin to the extracted second-order function to predict a chlorophyll-a concentration at the prescribed basin.

The input module may receive an operational land imager sensor image provided from LANDsat 8 satellite.

The correcting module may include: a TOA converting unit converting a value of a digital number in the image received from the satellite into a TOA reflectance ratio by using the following Equation:

ρλ′=M_{ρ}Q_{cal}+Aₚ

where ρλ′ denotes a TOA reflectance ratio for which a sun angle is not considered, M_{ρ} denotes a multiplicative rescaling factor of a metadata file, Aₚ denotes an additive rescaling factor of a metadata file, and Q_{cal} denotes a pixel of the image.

The TOA converting unit may extract a TOA reflectance ratio, for which a sun angle is considered, from the converted TOA reflectance ratio by using the following Equation:

$$ρ λ = \frac{ρ {λ}^{′}}{cos ( {θ}_{SZ} )} = \frac{ρ {λ}^{′}}{sin ( {θ}_{SE} )}$$

where ρλ denotes the TOA reflectance ratio for which the sun angle is considered, θ_{SE} denotes a sun angle at a measurement area, and θ_{SZ} denotes a solar zenith angle.

The function extracting module may generate sample data in which the corrected data of the satellite image, which was received on the same date and at the same site as when and where the chlorophyll-a concentration was measured at the measurement station, is taken as x, and a value of the chlorophyll-a concentration, which was actually measured at the measurement station, is taken as y.

The function extracting module may randomly extract three sample data points of P1(x₁,y₁), P2(x₂,y₂), and P3(x₃, y₃) from among the generated data.

The function extracting module may substitute the extracted three points to the following Equation to obtain a second-order function crossing the three points:

y=ax²+bx+c.

The function extracting module may obtain a number N of data of which distances to the obtained second-order function are equal to or greater than a prescribed value from the sample data generated therein.

The function extracting module may store N as a new maximum value N_max of N when N is greater than a stored maximum value N_max of N and stores a corresponding second-order function.

The function extracting module may randomly extract three points from among the sample data to obtain a second-order function crossing the three points, obtains a number N of sample data of which distances to the second-order function are equal to or smaller than a prescribed value, and when N is greater than a maximum value N_max of N, stores N as a new maximum N_max of N, and stores, as a final second-order function, a second-order function stored after the process for storing a corresponding second-order function is repeated a prescribed number of times.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a flowchart of a method for predicting a chlorophyll-a concentration in a river using satellite image data and a nonlinear RANSAC method according to an embodiment of the present invention;

FIG. 2 illustrates that chlorophyll-a concentrations, which are actually measured at a measurement station installed at a specific basin, are input in a method for predicting a chlorophyll-a concentration in a river using satellite image data and a nonlinear RANSAC method according to an embodiment of the present invention;

FIG. 3 illustrates a satellite image received from an operational land imager (OLI) provided from Landsat 8 satellite in a method for predicting a chlorophyll-a concentration in a river using satellite image data and a nonlinear RANSAC method according to an embodiment of the present invention;

FIG. 4 is a flowchart illustrating a process for correcting a distortion of an image received from a satellite in a method for predicting a chlorophyll-a concentration in a river using satellite image data and a nonlinear RANSAC method according to an embodiment of the present invention;

FIG. 5 is a flowchart illustrating a process for extracting a final second-order function by applying, to a nonlinear RANSAC method, actually measured chlorophyll-a concentrations and satellite image data corrected in step S200 in a method for predicting a chlorophyll-a concentration in a river using satellite image data and a nonlinear RANSAC method according to an embodiment of the present invention;

FIG. 6 illustrates second-order functions extracted from actually measured chlorophyll-a concentrations and corrected satellite image data in a method for predicting a chlorophyll-a concentration in a river using satellite image data and a nonlinear RANSAC method according to an embodiment of the present invention;

FIG. 7 illustrates a second-order function determined as the final second-order function for predicting chlorophyll-a concentrations, wherein the second-order function is obtained through steps S340 and S350 for each second-order function extracted from step S330 in a method for predicting a chlorophyll-a concentration in a river using satellite image data and a nonlinear RANSAC method according to an embodiment of the present invention;

FIG. 8 illustrates a distribution of chlorophyll-a concentrations predicted at a specific basin by inputting, to the final second-order function extracted from step S300, corrected data of satellite images, which are collected at the specific basin, in a method for predicting a chlorophyll-a concentration in a river using satellite image data and a nonlinear RANSAC method according to an embodiment of the present invention;

FIG. 9 illustrates a configuration of a system for predicting a chlorophyll-a concentration in a river using satellite image data and a nonlinear RANSAC method according to an embodiment of the present invention; and

FIG. 10 illustrates a detailed configuration of a correction module in a system for predicting a chlorophyll-a concentration in a river using satellite image data and a nonlinear RANSAC method according to an embodiment of the present invention.

### DESCRIPTION OF THE PREFERRED EMBODIMENTS

Hereinafter, embodiments of the present invention will be described in detail with reference to the accompanying drawings so that the present invention can be easily realized by those skilled in the art. Further, in the description of the present invention, when it is determined that the detailed description of the related functions and constructions would obscure the gist of the present invention, the description thereof will be omitted. In addition, like reference numerals refer to elements having like functions and operations throughout the drawings.

In addition, if certain parts are described as being connected to other parts, they are not only directly connected to the other parts, but also indirectly connected to the other parts with any other device intervened therebetween. In addition, when an element is referred to as “comprising” or “including” a component, it does not preclude another component but may further include the other component unless the context clearly indicates otherwise.

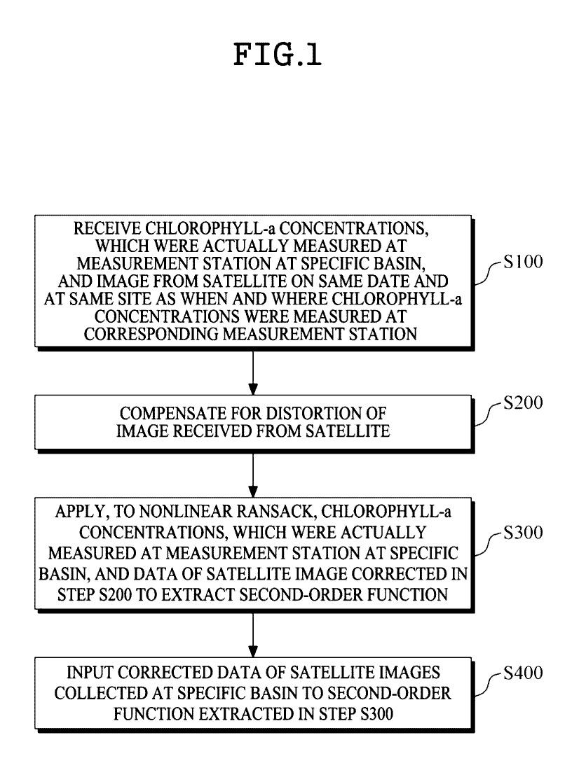

FIG. 1 illustrates a flowchart of a method for predicting a chlorophyll-a concentration in a river using satellite image data and a nonlinear RANSAC method. As illustrated in FIG. 1, a method for predicting a chlorophyll-a concentration in a river using satellite image data and a nonlinear RANSAC method according to an embodiment of the present invention may include (1) a step S100 for receiving chlorophyll-a concentrations at a specific basin, which were actually measured at a measurement station, and an image from a satellite on the same date and at the same site as when and where the chlorophyll-a concentrations were measured at the corresponding measurement station, (2) a step S200 for correcting a distortion of the image received from the satellite, (3) a step S300 for extracting second-order functions by applying, to a nonlinear random sample consensus (RANSAC) method, the chlorophyll-a concentrations actually measured at the measurement station and data of the satellite image corrected in step S200; and (4) a step S400 for inputting corrected data of satellite images, which are collected at a specific basin, to the second-order function extracted in step S300 and predicting chlorophyll-a concentrations at the corresponding basin.

Hereinafter, each step of a method for predicting a chlorophyll-a concentration in a river using satellite image data and the nonlinear RANSAC method proposed in the present invention will be described in detail with reference to the accompanying drawings.

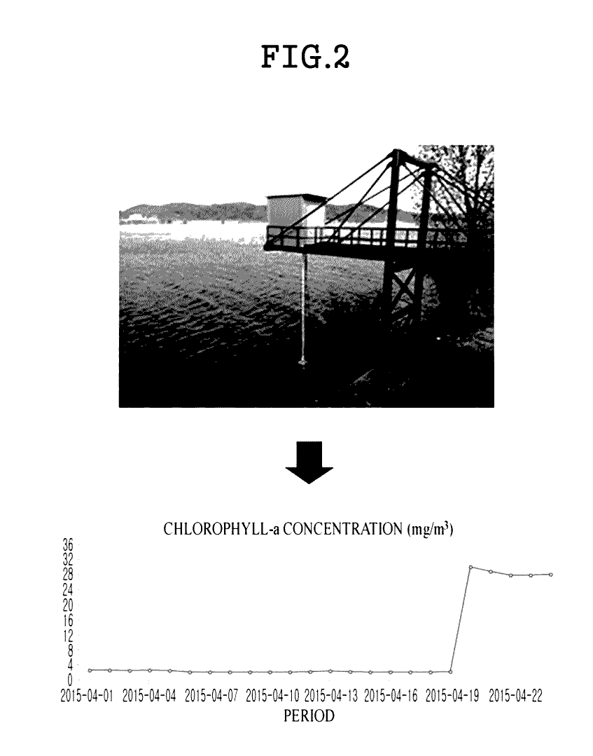

FIG. 2 illustrates that chlorophyll-a concentrations, which are actually measured at a measurement station installed at a specific basin, are input in a method for predicting a chlorophyll-a concentration in a river using satellite image data and a nonlinear RANSAC method. As illustrated in FIG. 2, values of chlorophyll-a concentrations, which are actually measured at the measurement station in the corresponding basin, may be received. In addition, through a homepage of National Institute of Environmental Research, water quality may be seen, including a hydrogen ion concentration (pH), electric conductivity (EC), dissolved oxygen (DO), total organic carbon (TOC), and total nitrogen (TN), etc., in addition to chlorophyll-a concentrations.

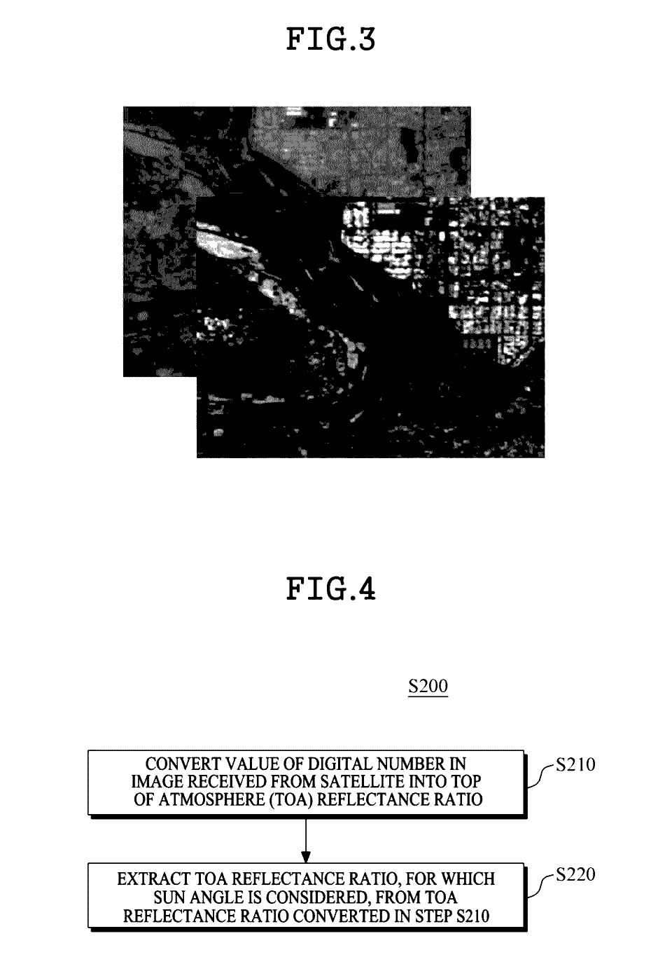

FIG. 3 illustrates a satellite image received from an operational land imager (OLI) provided from Landsat 8 satellite in a method for predicting a chlorophyll-a concentration in a river using satellite image data and a nonlinear RANSAC method according to an embodiment of the present invention. As illustrated in FIG. 3, in the present invention, the satellite image data may be received through an OLI sensor provided by the Landsat 9 satellite. Since the OLI sensor quantizes data into 12 bit data, the OLI sensor provides an excellent signal to noise ratio (SNR) compared to other sensors. In a method for predicting a chlorophyll-a concentration in a river using satellite image data and a nonlinear RANSAC method according to an embodiment of the present invention, OLI sensor images provided from the Landsat 8 satellite are used and accordingly better satellite image data may be received by virtue of an improved SNR performance.

FIG. 4 is a flowchart illustrating a process for correcting a distortion of an image received from a satellite in a method for predicting a chlorophyll-a concentration in a river using satellite image data and a nonlinear RANSAC method according to an embodiment of the present invention. Since the OLI sensor images are captured by a satellite outside the atmosphere, distortions may occur in the captured images due to a sun angle and variations of the earth and the sun according to a capturing time difference, and a spectrum difference between the inside and outside of the atmosphere. Accordingly a process for correcting the distortions of the images may be necessary. As illustrated in FIG. 4, step S200 for correcting the distortions of the images received from the satellite may include a step S210 for converting a value of a digital number in the image received from the satellite into a top of atmosphere (TOA) reflectance ratio and a step S220 for extracting a TOA reflectance ratio, for which a sun angle is considered, from the converted TOA reflectance ratio in step S210.

In step S210, the value of the digital number in the image, which is received from the satellite, may be converted into a TOA reflectance ratio by using the following Equation (1).

ρλ′=M_{ρ}Q_{cal}+Aₚ (1)

where ρλ′ denotes a TOA reflectance ratio for which a sun angle is not considered, M_{ρ} denotes a multiplicative rescaling factor of a metadata file, Aₚ denotes an additive rescaling factor of a metadata file, and Q_{cal} denotes a pixel of the image.

In step S220, the TOA reflectance ratio, for which the sun angle is considered, may be extracted from the TOA reflectance ratio converted in step S210 by using the following the following Equation (2).

$$ρ λ = \frac{ρ {λ}^{′}}{cos ( {θ}_{SZ} )} = \frac{ρ {λ}^{′}}{sin ( {θ}_{SE} )} \qquad ( 2 )$$

where ρλ denotes the TOA reflectance ratio for which the sun angle is considered, θ_{SE} denotes a sun angle at a measurement area, and θ_{SZ} denotes a solar zenith angle.

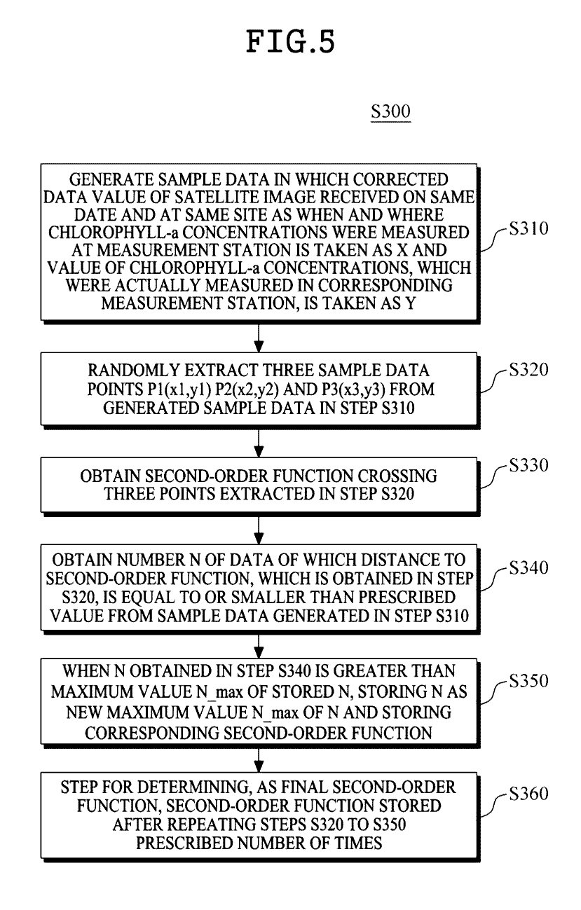

FIG. 5 is a flowchart illustrating a process for extracting a final second-order function by applying, to the nonlinear RANSAC method, actually measured chlorophyll-a concentrations and data of the satellite image corrected in step S200 in a method for predicting a chlorophyll-a concentration in a river using satellite image data and a nonlinear RANSAC method according to an embodiment of the present invention. As illustrated in FIG. 5, step S300 for extracting the second-order function by applying, to the RANSAC method, chlorophyll-a concentrations that were actually measured at a measurement station and data of the satellite image corrected in step S200 may include: a step S310 for generating sample data in which corrected data values of satellite images, which were received on the same date and at the same site as when and where the chlorophyll-a concentrations were measured at a measurement station, are taken as x, and values of the chlorophyll-a concentrations, which were actually measured at the corresponding measurement station, are taken as y; a step S320 for randomly extracting three sample data points P1(x₁,y₁) P2(x₂, y₂) and P3(x₃, y₃) from among the sample data generated in step S310; a step S330 for obtaining a second-order function, which crosses the three points extracted in step S320; a step S340 for obtaining the number N of data of which distances to the second-order function obtained in step S320 are equal to or smaller than a prescribed value; a step S350 for storing the corresponding N as a new maximum value of N (e.g. N_max) when N obtained in step S340 is greater than a stored maximum value (i.e. N_max) of N, and storing the corresponding second-order function; and a step S360 for determining, as a final second-order function, a second-order function stored after steps S320 to 350 are repeated the prescribed number of times.

In step S310, the sample data may be generated by taking the data values, which are obtained through step S200 by correcting the satellite images received on the same date and at the same site as when and where the chlorophyll-a concentrations were measured at the measurement station, as x, and by taking values of chlorophyll-a concentrations, which were actually measured at the corresponding measurement station, as y. Here, according to an embodiment, the sample data may be generated on the basis of data measured for several days, not for one day.

In step S320, three data points P1(x1,y1) P2(x2,y2), and P3(x3,y3) may be randomly extracted from among the sample data generated in step S310.

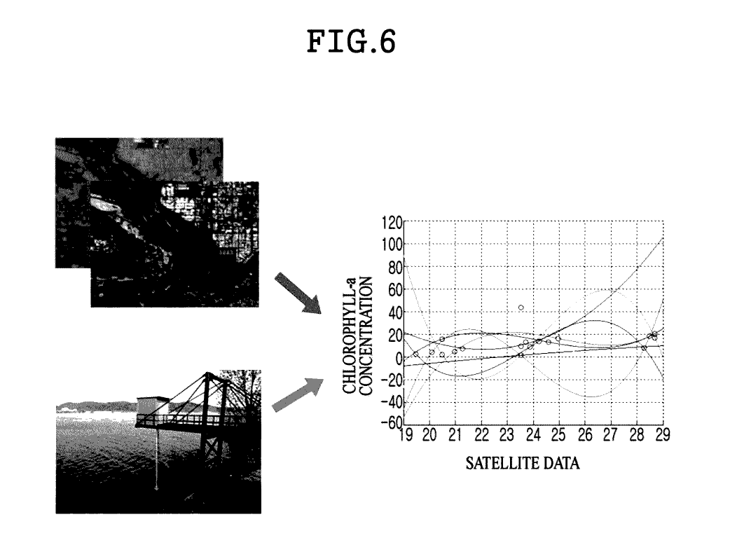

In operation S330, the three points extracted in step S320 are substituted to the following Equation (3) to obtain a second-order function, which crosses the three points, as illustrated in FIG. 6.

y=ax²+bx+c (3)

The nonlinear RANSAC method used herein may be used when data is nonlinearly configured. Typically, the RANSAC method is a parameter estimation method for selecting a model of which the number of supporting data is a greatest, and herein, the supporting data refers to data of which distances to an estimated model are equal to or smaller than the prescribed value. For example, in the RANSAC method, when the distance rᵢ=|yᵢ−f(xᵢ)| between data (xᵢ, yᵢ) and a model f(x) is equal to or smaller than the prescribed value, a corresponding data may be considered as data for supporting the model. Here, when the prescribed value is too great, models are not discriminated from each other, and when too small, the RANSAC method may be unstable.

In step S340, from the sample data generated in step S310, the number N of data, of which distances to the second-order function obtained in step S330 are equal to or smaller than the prescribed value, may be obtained.

In step S350, when the N obtained in step S340 is greater than the stored maximum value N_max of N, the N may be stored as the new maximum value N_max of N and the corresponding second-order function may be stored. Here, the maximum value N_max of N may be initialized as 0 at first. A pre-stored maximum value N_max of N is compared with the N obtained in step S340, and when the N obtained in step S340 is greater, the N obtained in step S340 is stored as the maximum value N_max and the corresponding second-order function may be stored. On the other hand, when the N obtained in step S340 is smaller the pre-stored maximum value N_max of N, the pre-stored N and the second-order function corresponding thereto may be stored as they are.

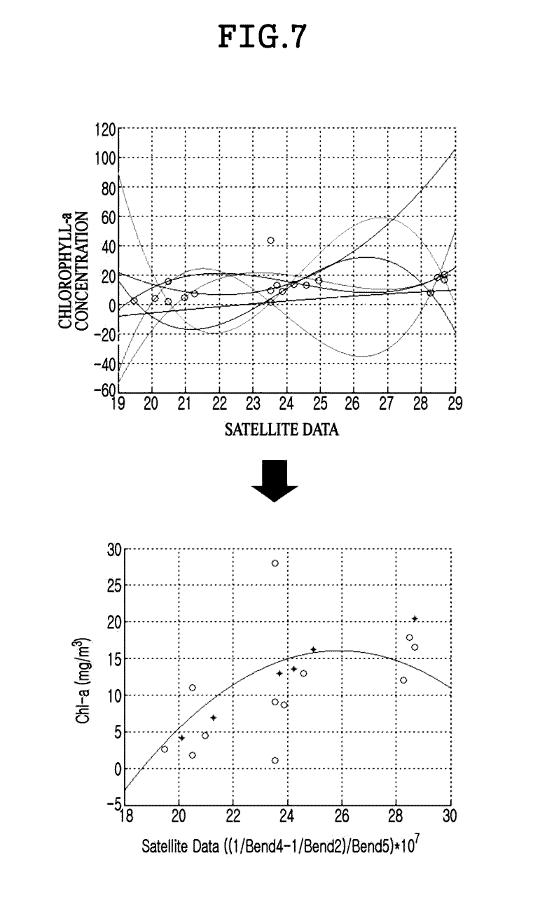

FIG. 7 illustrates a second-order function determined as a final second-order function for predicting chlorophyll-a concentrations, wherein the second-order function is obtained through steps S340 and S350 for each second-order function extracted from step S330, in a method for predicting a chlorophyll-a concentration in a river using satellite image data and a nonlinear RANSAC method according to an embodiment of the present invention. As illustrated in FIG. 7, in step S360, a second-order function, which is stored after steps S320 to S350 are repeated the prescribed number of times, may be determined as the final second-order function.

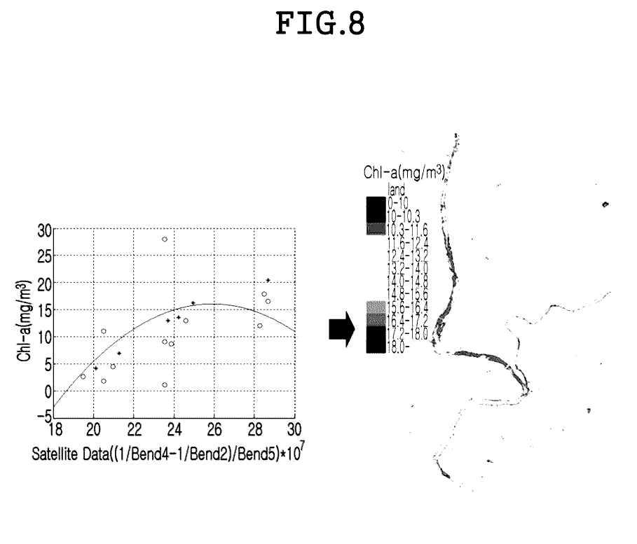

FIG. 8 illustrates a distribution of chlorophyll-a concentrations predicted at a specific basin by inputting, to the final second-order function extracted from step S300, corrected data of satellite images that are collected at the corresponding basin, in a method for predicting a chlorophyll-a concentration in a river using satellite image data and a nonlinear RANSAC method according to an embodiment of the present invention. As illustrated in FIG. 8, when the satellite image data corrected through step S200 is input to the second-order function, which is finally extracted through steps S310 to S360, chlorophyll-a concentrations at a site where the satellite images are collected may be predicted.

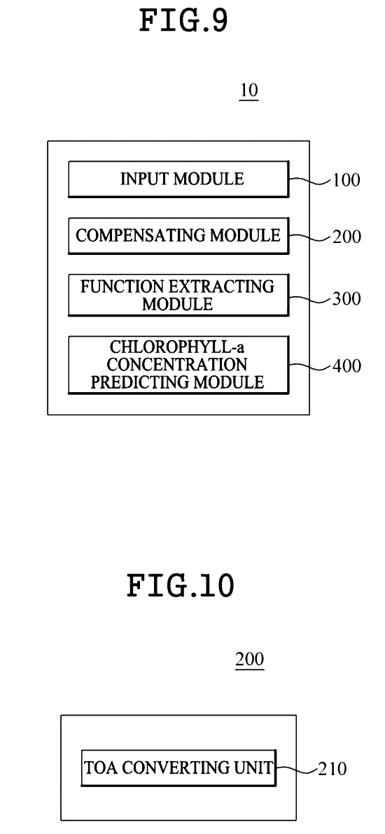

As illustrated in FIGS. 9 and 10, the above-described method for predicting a chlorophyll-a concentration in a river using satellite image data and a nonlinear RANSAC method may be realized by a system 10 for predicting a chlorophyll-a concentration in a river by using satellite image data and a nonlinear RANSAC method. The system 10 includes an input module 100 for receiving chlorophyll-a concentrations, which were actually measured at a measurement station at a specific basin, and images from a satellite on the same date and at the same site as when and where the chlorophyll-a concentrations were measured at the corresponding measurement station, a correcting module 200 including through a TOA converting unit 210 and for correcting distortions in the images received from the satellite, a function extracting module 300 for extracting a second-order function by applying, to the nonlinear RANSAC method, chlorophyll-a concentrations, which were actually measured at the measurement station, and data of the satellite image corrected by correcting module 200; a chlorophyll-a concentration predicting module 400 for predicting chlorophyll-a concentrations at the corresponding specific basin by inputting, to the extracted second-order function, data of satellite images collected at the specific basin and corrected.

In the system 10 for predicting a chlorophyll-a concentration in a river using satellite image data and a nonlinear RANSAC method, the input module 100 receives chlorophyll-a concentrations, which were actually measured at a measurement station, and images from an OLE sensor provided at Landsat 8 satellite on the same date and at the same site as when and where the chlorophyll-a concentrations were measured at the corresponding measurement station. Next, the correcting module 200 corrects, through the TOA converting unit 200, distortions in the images received from the input module 100. In addition, the function extracting module 300 extracts a second-order function by applying, to the nonlinear RANSAC method, chlorophyll-a concentrations, which were actually measured at a measurement station, and data of the satellite image corrected through the correcting module 200. Finally, the chlorophyll-a concentration predicting module 400 inputs the corrected data of the satellite images, which are collected at the specific basin, to the second-order function extracted through the function extracting module 300 to predict the chlorophyll-a concentrations at the corresponding basin.

According to a method and apparatus for predicting a chlorophyll-a concentration in a river using satellite image data and a nonlinear RANSAC method proposed in the present invention, a wide range of chlorophyll-a concentrations may be effectively predicted in rivers by inputting satellite image data collected at a specific basin to a second-order function, which is extracted by applying, to a RANSAC method, chlorophyll-a concentrations at the specific basin, which were actually measured at a measurement station, and data of images that were obtained from the satellite on the same date and at the same site as when and where the chlorophyll-a concentrations were measured at the corresponding measurement station.

In addition, the present invention enables an effect of outlier data to be minimized and chlorophyll-a concentrations to be more accurately predicted by using a nonlinear RANSAC method.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for predicting a chlorophyll-a concentration in a river using satellite image data and a nonlinear RANSAC method, the method comprising:
(1) receiving a chlorophyll-a concentration, which was actually measured at a measurement station at a prescribed basin and an image from a satellite on a same date and at a same site as when and where the chlorophyll-a concentration was measured at the measurement station;
(2) correcting a distortion of the image received from the satellite;
(3) applying the chlorophyll-a concentration actually measured at the measurement station and data of the corrected satellite image to a nonlinear RANSAC method to extract a second-order function; and
(4) inputting corrected data of a satellite image collected at the prescribed basin to the extracted second-order function to predict a chlorophyll-a concentration at the prescribed basin.

2. The method according to claim 1, wherein in step (1), an operational land imager sensor image provided from LANDsat 8 satellite is received.

3. The method according to claim 1, wherein step (2) comprises:
(2-1) converting a value of a digital number in the image received from the satellite into a top of atmosphere (TOA) reflectance ratio by using the following Equation:
ρλ′=M_{ρ}Q_{cal}+Aₚ
where ρλ′ denotes a TOA reflectance ratio to which a sun angle is not considered, M_{ρ} denotes a multiplicative rescaling factor of a metadata file, Aₚ denotes an additive rescaling factor of a metadata file, and Q_{cal} denotes a pixel of the image.

4. The method according to claim 3, wherein step (2) further comprises:
(2-2) extracting a TOA reflectance ratio, for which a sun angle is considered, from the TOA reflectance ratio converted in step (2-1) by using the following Equation:
$$ρ λ = \frac{ρ {λ}^{′}}{cos ( {θ}_{SZ} )} = \frac{ρ {λ}^{′}}{sin ( {θ}_{SE} )}$$
where ρλ denotes the TOA reflectance ratio for which the sun angle is considered, θ_{SE} denotes a sun angle at a measurement area, and θ_{SZ} denotes a solar zenith angle.

5. The method according to claim 1, wherein step (3) comprises (3-1) generating sample data in which the corrected data of the satellite image, which was received on the same date and at the same site as when and where the chlorophyll-a concentration was measured at the measurement station, is taken as x, and a value of the chlorophyll-a concentration, which was actually measured at the measurement station, is taken as y.

6. The method according to claim 5, wherein step (3) further comprises:
(3-2) randomly extracting three sample data points of P1(x₁, y₁), P2(x₂,y₂), and P3(x₃, y₃) from among the sample data generated in step (3-1).

7. The method according to claim 6, wherein step (3) further comprises:
(3-3) substituting the three points extracted in step (3-2) to the following Equation to obtain a second-order function crossing the three points:
y=ax²+bx+c.

8. The method according to claim 7, wherein step (3) further comprises:
(3-4) obtaining a number N of data of which distances to the second-order function obtained in step (3-3) are equal to or greater than a prescribed value.

9. The method according to claim 8, wherein step (3) further comprises:
(3-5) storing N as a new maximum value N_max of N when N obtained in step (3-4) is greater than a stored maximum value N_max of N and storing a corresponding second-order function.

10. The method according to claim 9, wherein step (3) further comprises:
(3-6) determining, as a final second-order function, a second-order function stored after repeating steps (3-2) to (3-5) a prescribed number of times.

11. A system for predicting a chlorophyll-a concentration in a river using satellite image data and a nonlinear RANSAC method, the system comprising:
an input module receiving a chlorophyll-a concentration at a predetermined basin, which was actually measured at a measurement station and an image from a satellite on a same date and at a same site as when and where the chlorophyll-a concentration was measured at the measurement station;
a correcting module correcting a distortion of an image received from the satellite;
a function extracting module applying the chlorophyll-a concentration actually measured at the measurement station and data of the corrected satellite image to a nonlinear RANSAC method to extract a second-order function; and
a chlorophyll-a concentration predicting module inputting corrected data of a satellite image collected at the prescribed basin to the extracted second-order function to predict a chlorophyll-a concentration at the prescribed basin.

12. The system according to claim 11, wherein the input module receives an operational land imager sensor image provided from LANDsat 8 satellite.

13. The system according to claim 11, wherein the correcting module comprises:
a TOA converting unit converting a value of a digital number in the image received from the satellite into a TOA reflectance ratio by using the following Equation:
ρλ′=M_{ρ}Q_{cal}+Aₚ
where ρλ′ denotes a TOA reflectance ratio for which a sun angle is not considered, M_{ρ} denotes a multiplicative rescaling factor of a metadata file, Aₚ denotes an additive rescaling factor of a metadata file, and Q_{cal} denotes a pixel of the image.

14. The system according to claim 13, wherein the TOA converting unit extracts a TOA reflectance ratio, for which a sun angle is considered, from the converted TOA reflectance ratio by using the following Equation:
$$ρ λ = \frac{ρ {λ}^{′}}{cos ( {θ}_{SZ} )} = \frac{ρ {λ}^{′}}{sin ( {θ}_{SE} )}$$
where ρλ denotes the TOA reflectance ratio for which the sun angle is considered, θ_{SE} denotes a sun angle at a measurement area, and θ_{SZ} denotes a solar zenith angle.

15. The system according to claim 11, wherein the function extracting module generates sample data in which the corrected data of the satellite image, which was received on the same date and at the same site as when and where the chlorophyll-a concentration was measured at the measurement station, is taken as x, and a value of the chlorophyll-a concentration, which was actually measured at the measurement station, is taken as y.

16. The system according to claim 15, wherein the function extracting module randomly extracts three sample data points of P1(x₁,y₁), P2(x₂,y₂), and P3(x₃,y₃) from among the generated data.

17. The system according to claim 16, wherein the function extracting module substitutes the extracted three points to the following Equation to obtain a second-order function crossing the three points:
y=ax²+bx+c.

18. The system according to claim 17, wherein the function extracting module obtains a number N of data of which distances to the obtained second-order function are equal to or greater than a prescribed value from the sample data generated therein.

19. The system according to claim 18, wherein the function extracting module stores N as a new maximum value N_max of N when N is greater than a stored maximum value N_max of N and stores a corresponding second-order function.

20. The system according to claim 19, wherein the function extracting module randomly extracts three points from among the sample data to obtain a second-order function crossing the three points, obtains a number N of sample data of which distances to the second-order function are equal to or smaller than a prescribed value, and when N is greater than a maximum value N_max of N, stores N as a new maximum N_max of N, and stores, as a final second-order function, a second-order function stored after the process for storing a corresponding second-order function is repeated a prescribed number of times.
